(19) United States
(12) Patent Application Publication
(10) Pub. No.: US 2016/0227811 A1
(43) Pub. Date: Aug. 11, 2016

(54) MOLD IN PLACE SYSTEM AND METHOD OF MAKING CONFECTIONERY PRODUCTS

(71) Applicant: THE HERSHEY COMPANY, Hershey, PA (US)

(72) Inventors: Stuart Michael Ruan Jones, Melbourn (GB); David Stonehouse, Cambridge (GB); Philip Russell FAWCUS, Cambridge (GB); Sandra HAND, Palmyra, PA (US); Rolland LORBACH, Palmyra, PA (US); Peter LORD, Hershey, PA (US)

(21) Appl. No.: 15/025,463

(22) PCT Filed: Oct. 2, 2014
(86) PCT No.: PCT/US2014/058838

§ 371 Date: Mar. 28, 2016

Related U.S. Application Data
(60) Provisional application No. 61/885,797, filed on Oct. 2, 2013.

(51) Int. Cl. A23G 1/00; A23G 1/22; A23G 3/02; A23G 3/54; B65B 63/08; A23G 1/26; B65B 25/00; B65B 31/00; B65B 47/04; A23G 3/34; A23G 1/54

(52) U.S. Cl. CPC A23G 1/0086; A23G 3/0034; A23G 1/226; A23G 3/0273; A23G 3/54; A23G 1/54; A23G 3/0278; A23G 1/26; B65B 25/005; B65B 31/00; B65B 47/04; B65B 63/08

(57) ABSTRACT

The present application discloses systems and methods for making confectionery products in which the product is formed in a cavity that forms part of the packaging for the product. In one embodiment the product is formed in film cavities (180) vacuum-formed into a carrier film (144) that is secured to a platen (124) from the forming step until the film cavities (180) are sealed. In another embodiment, the carrier film (144) is transported through the process via a continuous web.

### FIELD OF THE INVENTION

This present invention relates generally to systems and methods for forming and packaging food items, and more specifically to mold-in-package systems and methods for forming confectionery products directly in their final packaging.

### BACKGROUND OF THE INVENTION

In known confectionery production systems and methods, products are first formed in a mold and then must be sufficiently cooled, crystalline and/or solidified to be removed from the mold before packaging can occur. This increases the per-unit production time for these products, increases the length of the production line, results in higher production costs, limits the producer's ability to form the products into unique shapes and transfer the products into packaging without damaging the product, and places constraints on the producer's ability to adjust the dimensions of products due to concerns about product integrity during de-molding and packaging.

There is a need for improved systems and methods that overcome these and other drawbacks of the prior art.

### BRIEF SUMMARY OF THE INVENTION

### Aspects of the Invention

Additional aspects of the invention include:

Aspect 1. A method of making a confectionery having at least one component, the method comprising:
(a) forming at least one film cavity in a carrier film by causing each of the at least one film cavity to conform to and nest with one of at least one mold cavity of a first mold, each of the at least one mold cavity having a mold shape;
(b) depositing a first confectionery component of the at least one component into each of the at least one film cavity, the first confectionery component being in liquid phase at the beginning of the depositing step;
(c) cooling the deposited first confectionery component until it at least partially solidifies; and
(d) attaching a sealing film to the carrier film to create at least one sealed internal volume, each of the at least one sealed internal volume being defined by the sealing film and one of the at least one film cavity.

Aspect 2. The method of one or more of aspects 1-17, further comprising:
(e) after performing step (b), applying a forming mold having a forming shape to the deposited first confectionery component until the deposited first confectionery component is sufficient solidified to retain the forming shape when the forming mold is separated from the deposited first confectionery component.

Aspect 3. The method of one or more of aspects 1-17, further comprising, prior to and/or during the performance of step (e), cooling the forming mold to a temperature that is no greater than a temperature at which the first confectionery component will solidify.

Aspect 4. The method of one or more of aspects 1-17, further comprising:
(f) after performing step (b), depositing a second confectionery component of the at least one confectionery component into each of the at least one cavity.

Aspect 5. The method of one or more of aspects 1-17, further comprising:
(f) before performing step (b), depositing a second confectionery component of the at least one confectionery component into each of the at least one cavity, the second confectionery component being in solid phase.

Aspect 6. The method of one or more of aspects 4-17, further comprising:
(g) after performing step (f), depositing a top layer comprising the first confectionery component or a third confectionery component into each of the at least one cavity.

Aspect 7. The method of one or more of aspects 1-17, wherein the forming step comprises heating and applying a vacuum to each of the at least one film cavity.

Aspect 8. The method of one or more of aspects 7-17, wherein the step of applying a vacuum to each of the at least one film cavity comprises applying a vacuum to at least one hole formed in each of the at least one mold cavity.

Aspect 9. The method of one or more of aspects 1-17, further comprising:
(h) performing step (b) with each of the at least one film cavity nested with one of the at least one mold cavity.

Aspect 10. The method of one or more of aspects 1-17, further comprising:
(h) after performing step (a), keeping each of the at least one film cavity nested with one mold cavity at least until step (d) has been performed.

Aspect 11. The method of one or more of aspects 1-17, wherein step (a) comprises forming at least one film cavity of a carrier film by causing each of the at least one film cavity to conform to and nest with one of at least one mold cavity of a first mold, each of the at least one mold cavity having a mold shape, the first mold comprising a platen having a plurality of mold cavities.

Aspect 12. The method of one or more of aspects 1-17, further comprising:
(i) before performing step (a), extending over a platen a first portion of the carrier film from a roll of the carrier film, securing the first portion of the carrier film to the platen, and cutting the first portion of the carrier film thereby completely disconnecting the first portion of the carrier film from the roll of the carrier film.

Aspect 13. The method of one or more of aspects 1-17, further comprising:
(j) performing steps (a) through (d) along a path that is non-linear.

Aspect 14. The method of one or more of aspects 1-17, further comprising:
(k) providing a carrier film having sufficient rigidity to maintain a shape of the at least one film cavity if the first confectionery component is warmed to a liquid phase after step (d) has been performed.

Aspect 15. The method of one or more of aspects 1-17, further comprising:
(l) after performing step (d), cutting the carrier film and sealing film into a plurality of units, each unit comprising at least one of the at least one film cavity.

Aspect 16. The method of one or more of aspects 1-17, wherein step (d) further comprises bonding the sealing film to the carrier film, the sealing film having a thickness that is less than a thickness of the carrier firm.

Aspect 17. The method of one or more of aspects 1-17, wherein step (d) comprises attaching a sealing film to the carrier film, the sealing film comprising a portion of the carrier film.

Aspect 18. A method of making a confectionery having at least one component, the method comprising:
(a) securing a carrier film to a platen having a plurality of mold cavities, each of the plurality of mold cavities having a mold shape;
(b) forming a plurality of film cavities in the carrier film by causing the film to nest with and conform to the mold shape of each of the plurality of mold cavities;
(c) depositing a first confectionery component of the at least one component into each of the plurality of film cavities, the first confectionery component being in liquid phase at the beginning of the depositing step;
(d) cooling the deposited first confectionery component until it at least partially solidifies;
(e) attaching a sealing film to the carrier film to create a plurality of sealed internal volumes, each of the of sealed internal volumes being defined by the sealing film and one of the plurality of film cavities; and
(f) after performing step (b), keeping the carrier film secured to the platen and keeping each of the plurality of film cavities nested with one of the plurality of mold cavities at least until step (e) has been performed.

Aspect 19. The method of one or more of aspects 18-27, further comprising:
(g) after performing step (c), applying a forming mold having a forming shape to the deposited first confectionery component until the deposited first confectionery component is sufficient solidified to retain the forming shape when the forming mold is separated from the deposited first confectionery component.

Aspect 20. The method of one or more of aspects 19-27, further comprising, prior to and/or during the performance of step (g), cooling the forming mold to a temperature that is no greater than a temperature at which the first confectionery component will solidify.

Aspect 21. The method of one or more of aspects 18-27, further comprising:
(h) after performing step (c), depositing a second confectionery component of the at least one confectionery component into each of the plurality of film cavities.

Aspect 22. The method of one or more of aspects 18-27, further comprising:
(h) before performing step (b), depositing a second confectionery component of the at least one confectionery component into each of the at least one cavity, the second confectionery component being in solid phase.

Aspect 23. The method of one or more of aspects 21-27, further comprising:
(i) after performing step (h), depositing a top layer comprising the first confectionery component or a third confectionary component into each of the plurality of film cavities.

Aspect 24. The method of one or more of aspects 18-27, wherein the forming step comprises heating and applying a vacuum to each of the plurality of film cavities.

Aspect 25. The method of one or more of aspects 24-27, wherein the step of applying a vacuum to each of the plurality of film cavities comprises applying a vacuum to at least one hole formed in each of the plurality of mold cavities.

Aspect 26. The method of one or more of aspects 18-27, wherein step (a) further comprises extending over the platen a first portion of the carrier film from a roll of the carrier film, securing the first portion of the carrier film to the platen, and cutting the first portion of the carrier film thereby completely disconnecting the first portion of the carrier film from the roll of the carrier film.

Aspect 27. The method of one or more of aspects 18-27, wherein step (e) comprises attaching a sealing film to the carrier film, the sealing film comprising a portion of the carrier film.

### BRIEF DESCRIPTION OF THE DRAWINGS

The foregoing summary, as well as the following detailed description of the invention, will be better understood when read in conjunction with the appended drawings. For the purpose of illustrating the invention disclosed herein, certain embodiments in accordance with the herein disclosed invention are shown in the drawings. It should be understood, however, that the herein disclosed invention is not limited to the precise arrangements shown. It should also be understood that, in the drawings, the parts are not necessarily drawn to scale. The present invention will hereinafter be described in conjunction with the appended drawing figures, wherein like numerals denote like elements. In the drawings:

FIG. 1 is a schematic top plan view of a first embodiment of a line according to the present invention;

FIG. 2 is a flow chart detailing steps of the stations thereof;

FIG. 3a is a top perspective view of a platen for forming confectionery products according to the present invention;

FIG. 3b is a bottom perspective view thereof;

FIGS. 4a and 4b are perspective views of steps performed at a film and frame loading station of the line of FIG. 1;

FIGS. 5a-5c are perspective views of steps performed at a thermoforming station thereof;

FIGS. 6a-6c are perspective views of steps performed at a sealing station thereof;

FIGS. 7a-7c are perspective views of steps performed at a cut station thereof;

FIG. 8 is a schematic perspective view of a second embodiment of a line according to the present invention;

FIG. 9 is a perspective view of a thermoforming station thereof;

FIG. 10 is a close-up partial view of a cutting station thereof;

FIG. 11 is a schematic perspective view of a third embodiment of a line according to the present invention;

FIG. 12 is a close-up partial view of a film feeding and thermoforming station thereof;

FIG. 13 is a close-up partial view of a filling and cooling station thereof;

FIG. 14a is a perspective view of a cutting station thereof; and

FIG. 14b is a close-up partial view of the cutting station shown in FIG. 14a.

### DETAILED DESCRIPTION OF THE PREFERRED EMBODIMENTS

The ensuing detailed description provides preferred exemplary embodiments only, and is not intended to limit the scope, applicability, or configuration of the herein disclosed inventions. Rather, the ensuing detailed description of the preferred exemplary embodiments will provide those skilled in the art with an enabling description for implementing the preferred exemplary embodiments in accordance with the herein disclosed invention. It is understood that various changes may be made in the function and arrangement of elements without departing from the spirit and scope of the invention, as set forth in the appended claims.

To aid in describing the invention, directional terms may be used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification, in order to provide context for other features.

In the claims, letters are used to identify claimed steps (e.g., (a), (b), and (c)). These letters are used to aid in referring to the method steps and are not intended to indicate the order in which claimed steps are performed, unless and only to the extent that such order is specifically recited in the claims.

Mold-in-place packaging provides several benefits over prior art methods of making confectioneries. No transfer from a mold to packaging is required, thereby simplifying production. The product form follows the form of the pack, thereby increasing opportunities for three-dimensional product production and branding. Mold-in-place production renders the product more easily and cleanly removable from the pack. The product can be made more easily accessible through a peelable lid. The product packaging base and lid materials can differ, thereby imparting different aesthetic and/or functional characteristics.

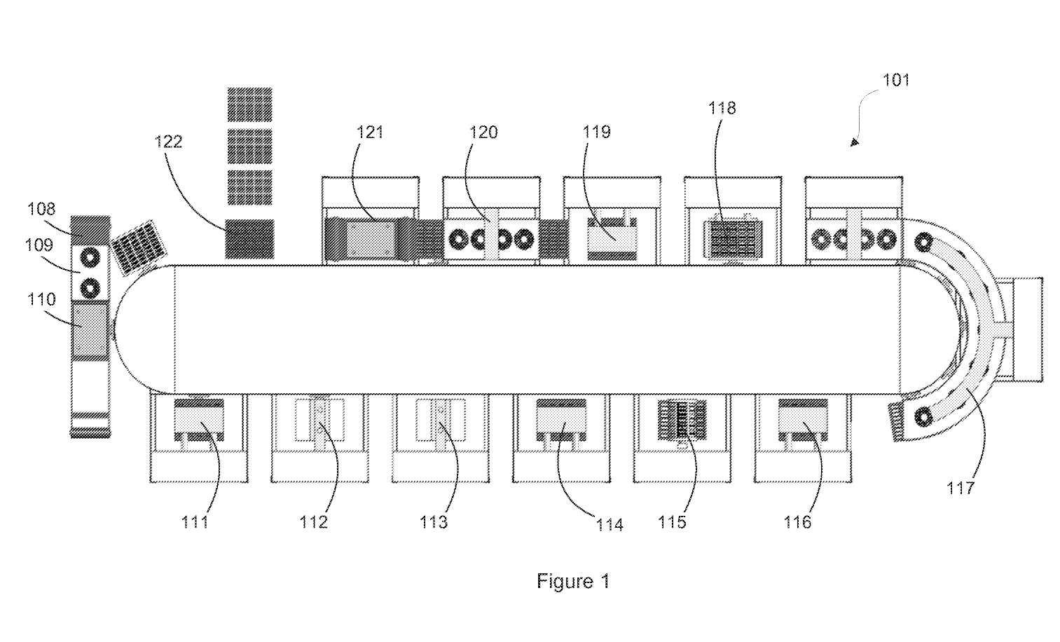

Referring to FIG. 1, a first embodiment of a production line 101 for forming confectionery products, comprising a plurality of stations, will be described in detail. In this embodiment, the line 101 comprises—in sequential order—a film and frame loading station 108, a thermoforming station 110, a depositor station 111, cold stamping stations 112,113, a filling A station 114, a wafer/biscuit station 115, a filling B station 116, a cooling station 117, an inserter station 118, a deposit station 119, a cooling station 120, a sealing station 121, and a cut station 122. Packing of the product and additional cooling steps (not shown) will often be performed after the product has been cut at the cut station 122.

The arrangement of stations between the thermoforming station 110 and the sealing station 121 will depend upon the product being made. For example, a filled chocolate product may require the depositor station 111 (to deposit chocolate), cold stamping station 112 (to form the deposited chocolate into a shell), filling A station 114 (to introduce the filling), and deposit station 119 (to apply the top layer of chocolate). In this example, the wafer/biscuit station 115, filling B station 116, cooling station 117, and inserter station 118 could be omitted.

A pre-heater 109 could optionally be provided as part of the film and frame loading station 108 to pre-heat and thereby softens the carrier film before it is loaded onto the platen. The pre-heater 109 is more likely to be needed for relatively thick and/or stiff carrier films.

In this embodiment, the line 101 is operated in a non-continuous manner using a moveable platen in which the product is formed and packaged. As will be described in further detail below, in this embodiment, the platen is transported from station to station with the carrier film attached. The non-continuous platen based line 101 allows for independent control at each of the stations, with the individual platens used as carrying supports at every stage of the product forming process.

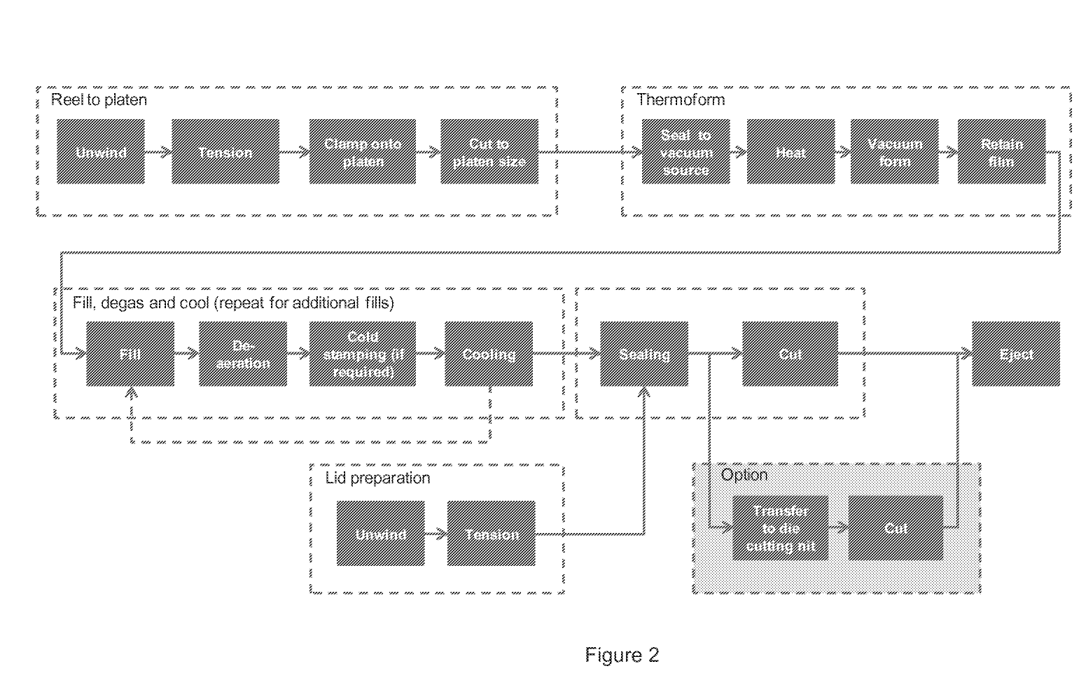

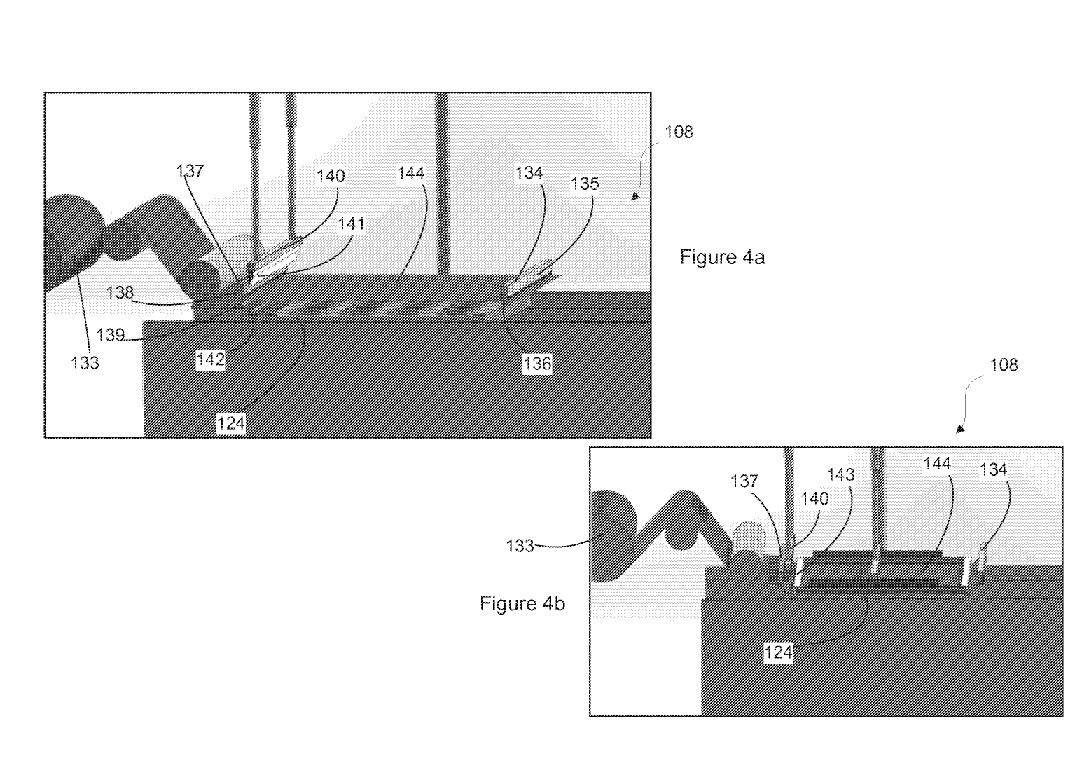

FIG. 2 is a flow chart detailing exemplary steps performed at various stations of the line 101. At the film and frame loading station 108, as shown in FIGS. 4a and 4b, a thermoplastic film is unwound from a reel, placed under tension, secured to a platen, and the thermoplastic film is then cut approximately to the size of the platen. At the thermoforming station 110, the platen is sealed to a vacuum source, the film is heated and vacuum formed into one or more mold cavities in the platen to form corresponding film cavities, and the film is retained in place on the platen. In alternate embodiments, pressure forming could be used instead of vacuum forming. If pressure forming is used, it could optionally be implemented with a plug assist.

At depositor station 111, a confectionery (e.g., chocolate) is deposited into the at least one film cavity to form the base of the product, and if necessary the product is agitated or vibrated in one or more planes to spread the confectionary and/or remove air from the confectionery. If necessary, the confectionery is then cold stamped at one or both of cold stamping stations 112,113 using one or more tools (e.g., a “frozen cone,” as would be appreciated by one having ordinary skill in the art) in order to partially cool the confectionery and shape it such that one or more fillings and/or inclusions (e.g., nuts, candies, toppings) can be provided. At additional stations: if applicable, one or more fillings and or biscuits/wafers can be placed on top of the product at stations 114,115,116; if necessary the product can be further cooled at cooling station 117; if applicable additional inclusions can be placed on top of the confectionery at inserter station 118; if applicable a top layer of confectionery (e.g., chocolate) can be placed on top of the product at depositor station 119; and if necessary the product can be further cooled at cooling station 120.

Stations 111-120 of the present embodiment can be implemented using methods and equipment known in the art. It should further be understood that the selection and arrangement of stations 111-120 is based on the particular characteristics and components of the confectionery which is being produced on the line 101, and that stations may be added or removed from the line 101 as necessary based on the confectionery that is to be produced on the line 101.

In this embodiment, the film cavity 180 is sealed by attaching a top layer of film thereto at sealing station 121, thereby forming a filled-in pack that holds one or more units of confectionery product. If necessary, individual units of product are then cut apart at cut, pack, and cool station 122, where the product is also removed from the line 101 and packaged. In other embodiments, sealing could be performed by folding a portion of the cavity film 144 over the film cavity 180 instead of providing a separate layer of film.

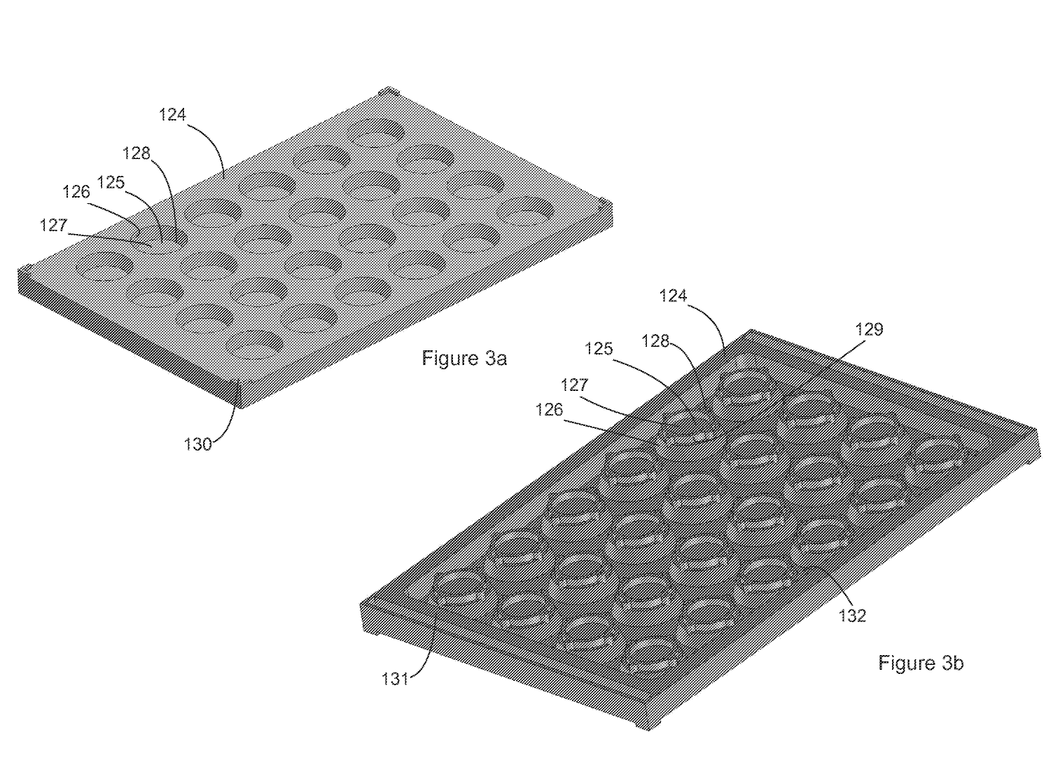

Referring now to FIGS. 3a and 3b, a platen 124 according to the present embodiment will be described. In this embodiment, the platen 124 comprises a plurality of mold cavities 125, each of the mold cavities 125 comprising a wall 126, a floor 127, and a plurality of vacuum holes 128 located therein. The upper side of the platen 124 may contain a plurality of corner guides 130 that may be used to align the platen 124 during later stations within the line 101. The lower side of the platen 124 comprises a perimeter wall 131 and an interconnected volume 132 that extends around and between the lower sides of the mold cavities 125. As can be seen in FIG. 3b, each of the vacuum holes 128 extend through the platen 124, and the lower side of each mold cavity 125 comprises an extension 129 that increases the rigidity of the platen 124 and reduces deformation thereof during the thermoforming step.

The functionality of the thermoforming station 110 is shown in FIGS. 4a and 4b. In order to index the carrier film 144 onto the platen 124, first the platen 124 is placed onto a support surface and the carrier film 144 is fed off of a reel 133, over top the platen 124, until it extends at least to a front gripper 134. The leading end of the carrier film 144 is clamped between an upper portion 135 and a lower portion 136 of the front gripper 134, and the trailing end of the carrier film 144 is clamped between an upper portion 138 and a lower portion 139 of a rear gripper 137. A frame 143 is then placed on top of the carrier film 144 and platen 124 to index the carrier film 144 in place. A cutter 140 comprising a blade 141 and a lower portion 142 is then used to cut the carrier film 144 behind the rear gripper 137. In this embodiment, the portion of the carrier film 144 secured to the platen 124 is completely disconnected from film remaining on the reel 133 after being cut.

Many different materials and material gauges (thicknesses) are available for use as thermoforming films. The materials used range from soft materials to semi-rigid materials, and include but are not limited to PP, PE, PA/PE, PC/PE, PETg, and PVC. Preferred thicknesses are between 65 micrometers and approximately 300 micrometers. The material used for sealing films can have similar characteristics to the material used for the carrier film (i.e., for forming the film cavities), or the sealing films can be thinner since there is no need to thermoform the sealing film.

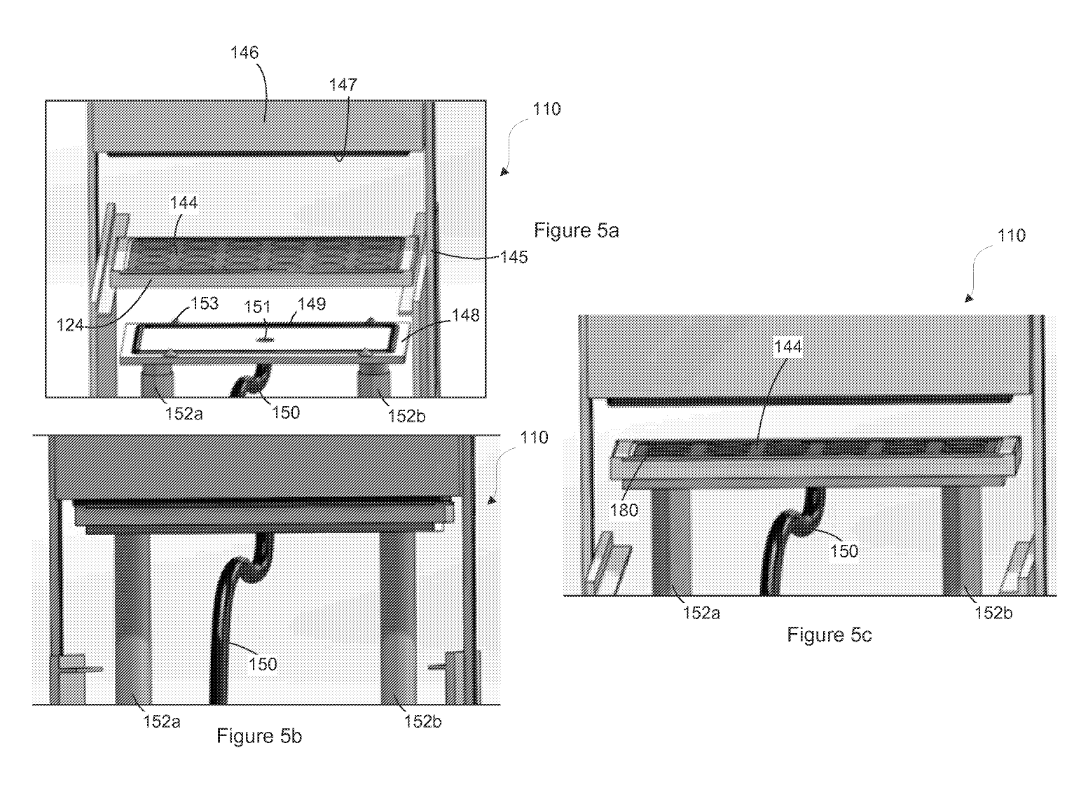

As shown in FIGS. 5a-5c, the platen 124 is then transferred to the thermoforming station 110 where the one or more film cavities 180 are formed in the carrier film 144. As shown in FIG. 5a, the platen 124 is supported by a frame 145 below a heater 146, which in this embodiment is an infrared heater. Located below the platen 124 is a plate 148 having an opening 151 therein. The opening 151 is attached to a vacuum hose 150, which is attached to a vacuum source (not shown). The height of the plate 148 and attached vacuum hose 150 is adjustable via a pair of lift shafts 152a,152b so that the plate 148 can be brought into contact with the lower side of the platen 124. The upper side of the plate 148 comprises a plurality of locating pins 153 that help to align the plate 148 with the platen 124 and support the platen 124 after it has been lifted off of the frame 145. The upper side of the plate 148 also comprises a sealing strip 149 that forms a vacuum-tight seal with the lower side of the platen 124 when the plate 148 is brought into contact with the platen 124 with a sufficient amount of pressure. The lower side of the heater 146 also comprises a compression strip 147. The compression strip 147 makes a vacuum-tight seal between the film and the upper side of the platen 124 when the platen has been brought into contact with the platen 124 with a sufficient amount of pressure. As shown in FIG. 5b, the lift shafts 152a,152b are used to bring the plate 148 into contact with the platen 124, lift the platen 124 off of the frame 145, and bring the platen into contact with the lower side of the heater 146. The heater 146 is used to soften the material of the carrier film 144. Once sufficient pressure has been applied to both the upper and lower sides of the platen 124, the vacuum source is used to draw a vacuum through the vacuum hose 150, thereby evacuating the air from the volume located between the sealing strip 149 and the underside of the carrier film 144 clamped on to the top of the platen 124. Due to the presence of the plurality of vacuum holes 128 through the one or more mold cavities 125 of the platen 124, the carrier film 144 is stretched and drawn into each of the one or more mold cavities 125 in a conforming manner, thus forming a film cavity 180 (see FIG. 5c) within each of the mold cavities 125.

Once the film cavities 180 have been formed within the platen 124, the platen 124 is lowered away from the heater 146, as shown in FIG. 5c. Once the film cavities 180 have been formed, the platen 124 is then moved through an appropriate combination of stations in order to fully prepare the confectionery, the specific steps being performed depending upon the shape and composition of the confectionery. During one or more of the steps in which components of the confectionery product are inserted into the film cavity 180, it may be desirable to apply a vacuum to the film cavities 180 to hold the film civilities 180 in a firmly nested position within each respective mold cavity 125. This is most likely to be desirable during the step in which the first component of the confectionery product is deposited. Once the confectionery has been fully prepared, the platen 124 is then moved to the sealing station 121. Once the film cavities 180 have been formed, each film cavity 180 preferably remains nested in a respective one of the mold cavities 125 until after the sealing step has been performed in the sealing station 121. In this embodiment, the mold cavities 125 are female molds formed in the platen 124. In other embodiments, male molds could be used.

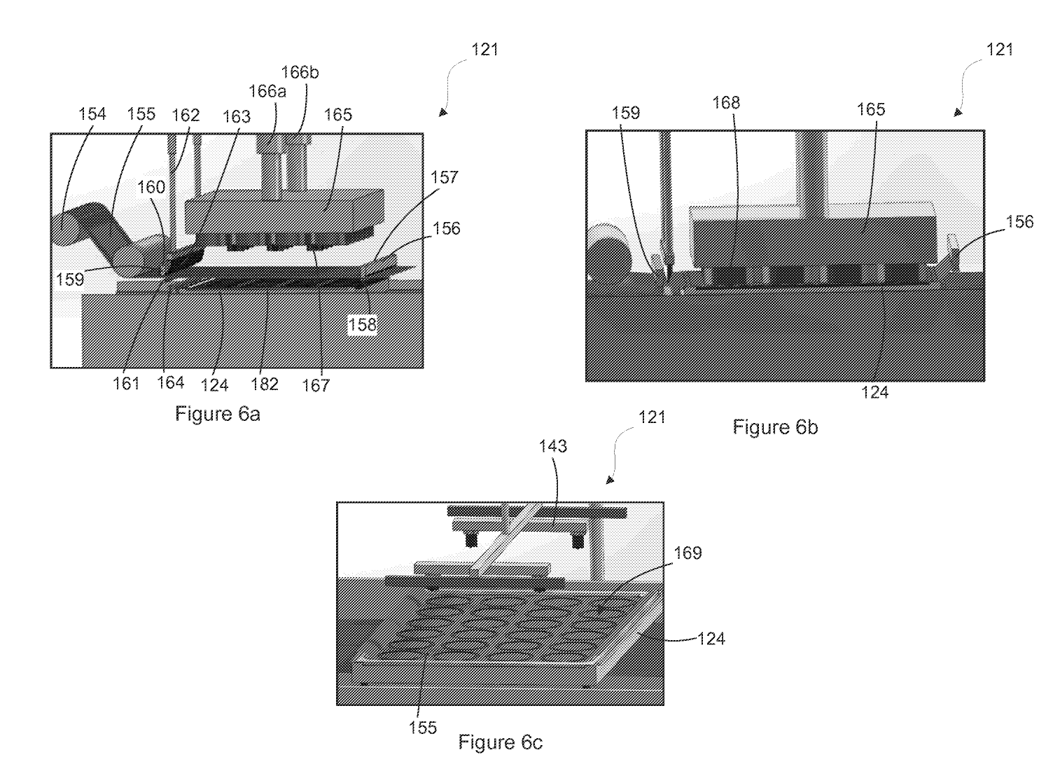

As shown in FIGS. 6a-6c, the platen 124 is transferred to the sealing station 121, where a sealing film 155 is used to seal each or a plurality of the film cavities 180, thus defining an internal volume and encasing a confectionery 182 therein. In this embodiment the sealing film 155 is also a thermoplastic and may be comprised of the same material as the carrier film 144. Alternatively, the sealing film 155 could be thinner and/or less rigid, or thicker and/or more rigid. In further alternate embodiments, the sealing film 155 could consist of a portion of the carrier film 144 that is folded over the film cavities 180, then sealed in place.

As shown in FIG. 6a, the sealing film 155 is fed from a lid film reel 154 and over the platen 124 until it extends at least to a front gripper 156. The leading end of the sealing film 155 is clamped between an upper portion 157 and a lower portion 158 of the front gripper 156, and the trailing end of the sealing film 155 is clamped between an upper portion 160 and a lower portion 161 of a rear gripper 159. A cutter 162 comprising a blade 163 and a lower portion 164 is then used to cut the sealing film 155 behind the rear gripper 159. As shown in FIG. 6b, a sealing unit 165 is then lowered down via a pair of shafts 166a,166b such that a plurality of inner sealing heads 167 are each brought into indirect contact with the platen 124 outside of the upper perimeter of a respective film cavity 180, and a plurality of outer sheaths that each surround a respective inner sealing head 167 are likewise lowered into contact with the sealing film 155. As shown in FIG. 6c, once the sealing film 155 has been sealed in respective locations to the top of the carrier film 144, the frame 143 is removed via one or more electromagnets (not shown) and an array of filled-in packs 169 has been created. It should be understood that this array 169 can comprise one or more individual units of confectionery product.

Optionally, a vacuum could be used as the sealing film 155 is being applied in order to cause the sealing film 155 to conform to the top surface of the confectionery product. This may be particularly desirable in embodiments in which the top of the confectionery product protrudes from the film cavity 180 or if it is desirable to reduce the head space of the confectionery product.

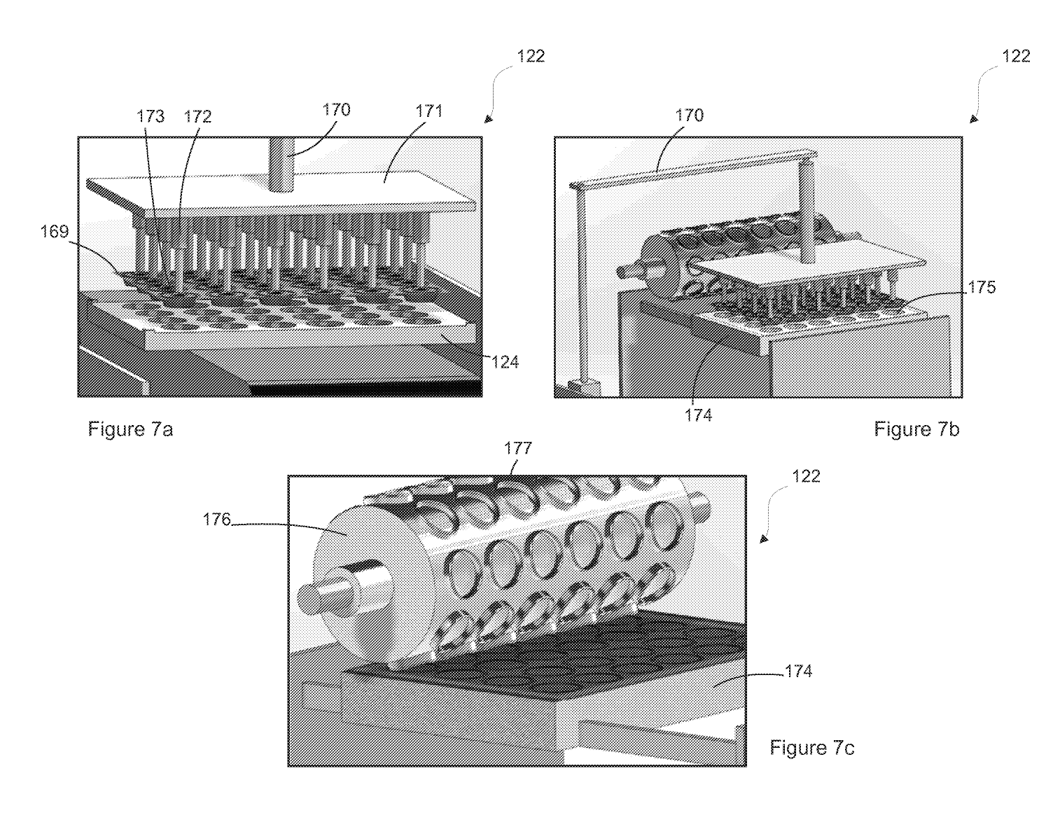

Once the array of filled-in packs 169 has been created, in this embodiment the array 169 is transferred to cut station 122. As shown in FIGS. 7a and 7b, at the cutting station 122 a robot arm 170 is used to pick up the array of filled-in packs 169 and move it to a cutting location. The robot arm 170 comprises a top plate 171 and a plurality of vacuum extensions 172, each of which terminates in a vacuum head 173 that is brought into contact with the array 169. The vacuum heads 173 are operably connected to a vacuum source (not shown), which allows the vacuum heads 173 to create a seal with the array 169 and use the force of the suction provided by the vacuum source to lift and transfer the array 169. As shown in FIG. 7b, a cutter plate 174 having a plurality of pack cavities 175—each of which corresponds with the size and dimensions of an individual unit of confectionery product of the array 169—supports the array 169 during the cutting step of the process. As mentioned above, in alternate embodiments, the cutter plate 174 could be configured to correspond to the size of a plurality of units of the confectionery product in the array 169.

As shown in FIG. 7c, a die cutter 176 having a plurality of appropriately-sized blades 177 is then used to cut through the layers of film 155,144 so that individual units of filled-in-pack confections are created. In this embodiment, the die cutter 176 is a rotary cutter that functions by rolling along its longitudinal axis over the cutter plate 174. In alternate embodiments, the die cutter 176 may be a plate-style cutter or could comprise one or more anvil-style linear or grid-like cutting blades, as appropriate based on the arrangement of the array 169. After the cutting step, waste film is removed from the cutter plate 174, and optionally an additional active cooling step may occur at this point. The filled-in-pack confections are then transferred to a packaging station (not shown), where they are packaged for end use, display, and/or transport.

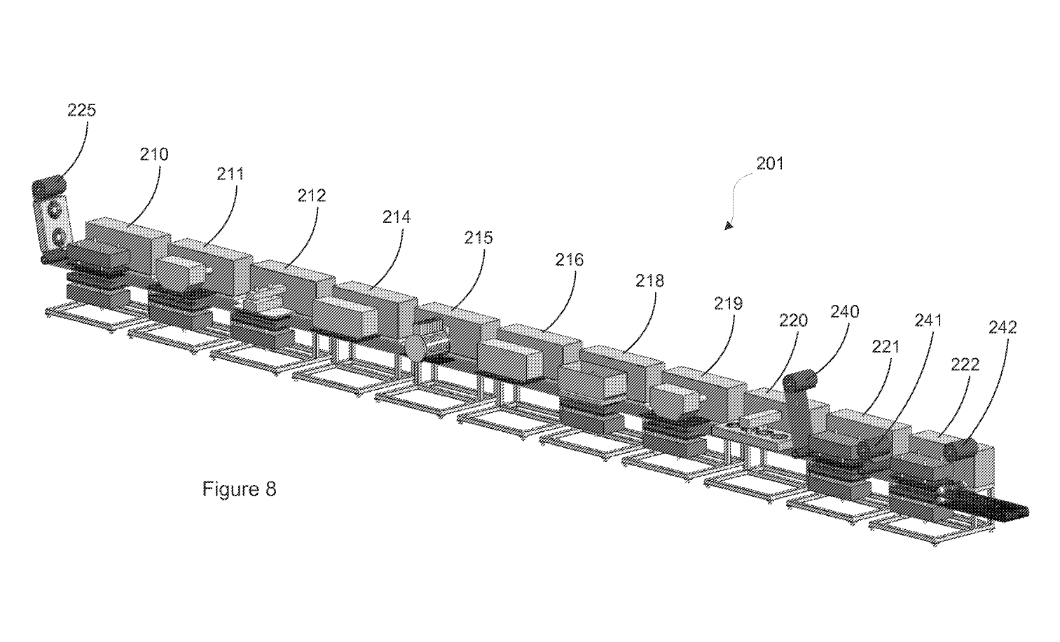

Referring now to FIGS. 8-10, a second embodiment of a line 201 for forming confectionery products in place, comprising a plurality of stations, will be described in detail. Generally, the line 201 of FIGS. 8-10 differs from the line 101 of FIGS. 1-7c in that, in the line 201, any platens used as part of the production process remain at each station and the reel of film that is used to form the one or more film cavities is maintained as a continuous web throughout the forming and filling stations and is simultaneously used to advance the confectionery product from station to station.

As shown in FIG. 8, the line 201 comprises a reel 225 from which the film 226 is fed to the line 201, a film feeding and thermoforming station 210, a depositor A station 211, a cold stamping station 212, a depositor B station 214, a wafer/biscuit station 215, a depositor C station 216, an inserter station 218, a depositor D station 219, a cooling station 220, a sealing station 221, and a cutting station 222. The stations 211-220 should be understood to be comparable to those discussed above with respect to the embodiment of FIGS. 1-7c, and will not be discussed again in detail. It should be understood that the selection and arrangement of stations 211-220 is based on the particular characteristics and components of the confectionery which is being produced on the line 201, and that stations may be added or removed from the line 201 as necessary based on the confectionery that is to be produced on the line 201. Where the film that is being used to form the film cavities is above a certain minimum thickness, it is preferable to provide a pre-heater 209 as part of the film feeding and thermoforming station 210 that pre-heats and thereby softens the film 226 before it is fed into the thermo former.

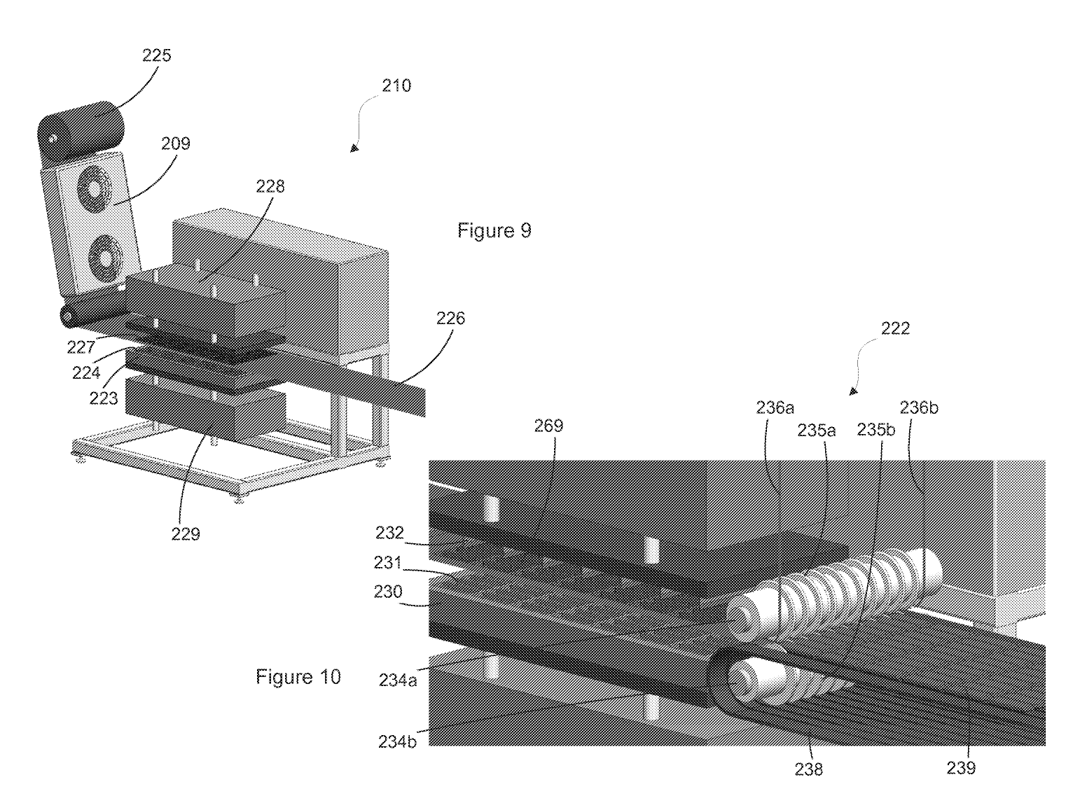

As seen in FIG. 9, the film feeding and thermoforming station 210 comprises a cavity forming plate 223 comprising a plurality of mold cavities 224. The film 226 is fed from the reel 225 over the top of the cavity forming plate 223 and indexed in place. A vacuum former 229 is provided below the cavity forming plate 223, and is operably connected to a vacuum source (not shown). The cavity forming plate 223 has a plurality of vacuum holes (not shown) located therein, corresponding with individual mold cavities 224. A heater 228, which in this embodiment is an infrared heater, is provided above the cavity forming plate 223. The heater 228 is brought down into contact with the upper side of the cavity forming plate 223 and the vacuum former is brought up into contact with the lower side of the cavity forming plate 223, thereby sealing the film 226 therein. The vacuum source is then activated, which after evacuating the air from the volume draws the film 226 into the mold cavities 224 to form corresponding film cavities 227, as shown in FIG. 9. After the thermoforming step, the film 226 is then advanced through the stations 211-220 via the use of a series of edge-grabbing mechanisms that intermittently hold the outer edges of the film 226 and advance the film 226 through the various stations of the line 201. The sealing station 221 of the line 201 of FIGS. 8-10 is conceptually the same as the sealing station 121 of the line 101 of FIGS. 1-7c discussed above, and comprises a lid film reel 240 and a sealing waste take-up reel 241 (see FIG. 8) that collects the unused sealing film after the array of filled-in packs 269 has been formed.

FIG. 10 shows a portion of a cutting station 222 of the line 201. Once the array of filled-in packs 269 has been formed, the film advancement mechanisms move the array 269 into a cutter plate 230 having a plurality of pack cavities 231, which supports the array 269 during the cutting step of the process. In this embodiment, the cutting station 222 has a plurality of cross-cut blades 232 that cut the array 269 widthwise. A pair of rotary cutters 234a,234b, each having a plurality of blades 235a,235b, are used to cut the array in the opposite directions, thereby leaving a plurality of filled-in packs 239. In other embodiments, it may be preferable to position the rotary cutters 234a, 234b before the cross-cut blades 232.

The filled-in packs 239 are then moved via a belt 238, optionally to an additional cooling station or a packaging station (not shown). In this embodiment, the die cutters 234a,234b are rotary cutters that function by spinning in place about their respective longitudinal axis. In alternate embodiments, the die cutter(s) may be a plate-style cutter or could comprise one or more anvil-style linear or grid-like cutting blades, as appropriate based on the arrangement of the array 269. In this embodiment, after the cutting step, the trimmed edge material 236a,236b is taken up by the cutting waste take-up reel 242 (see FIG. 8).

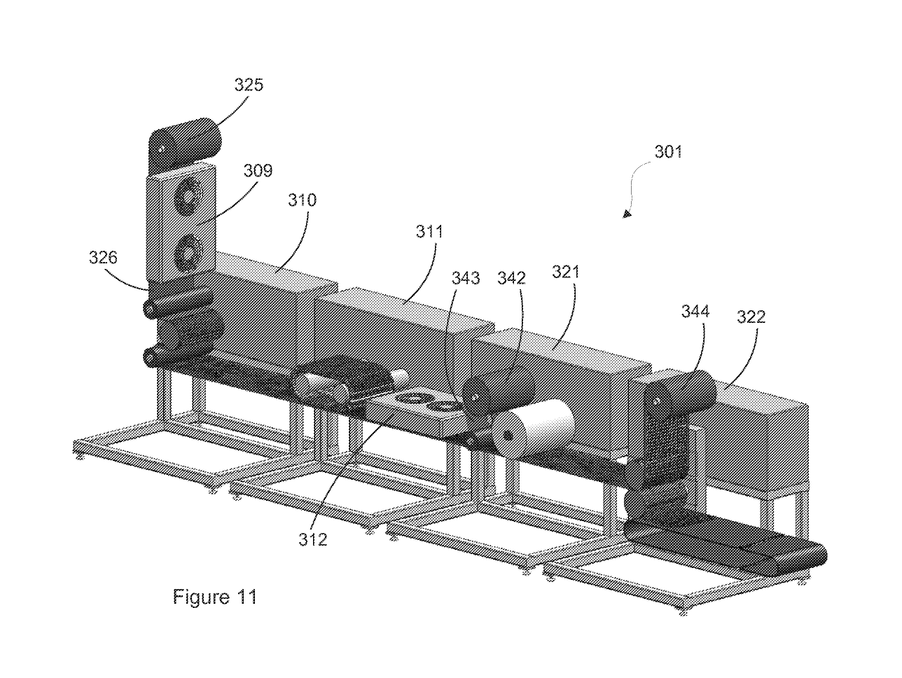

Referring now generally to FIGS. 11-14b, a third embodiment of a line 301 for forming confectionery products in place, comprising a plurality of stations, will be described in detail. Generally, the line 301 of FIGS. 8-10 differs from the line 201 of FIGS. 8-10 in that the line 301 operates in a true continuous manner without any intermittent pauses at individual stations. The overall output rate of the line 301 is primarily dictated by the speed of its slowest operating station, which may be the filling and cooling station 311. In the line 301 shown in FIGS. 11-14b, the confectionery is of a single component (e.g., a single chocolate layer); therefore, no depositor, inserter, or other intermediate stations are provided in the line 301.

As shown in FIG. 11, the line 301 comprises a reel 325 from which the film 326 is fed to the line 301, a film feeding and thermoforming station 310, a filling and cooling station 311 comprising a cooling unit 312, a sealing station 321, and a cutting station 322. Where the film that is being used to form the film cavities is above a certain minimum thickness, it is preferable to provide a pre-heater 309 as part of the film feeding and thermoforming station 310 that pre-heats and thereby softens the film 326 before it is fed into the thermoformer.

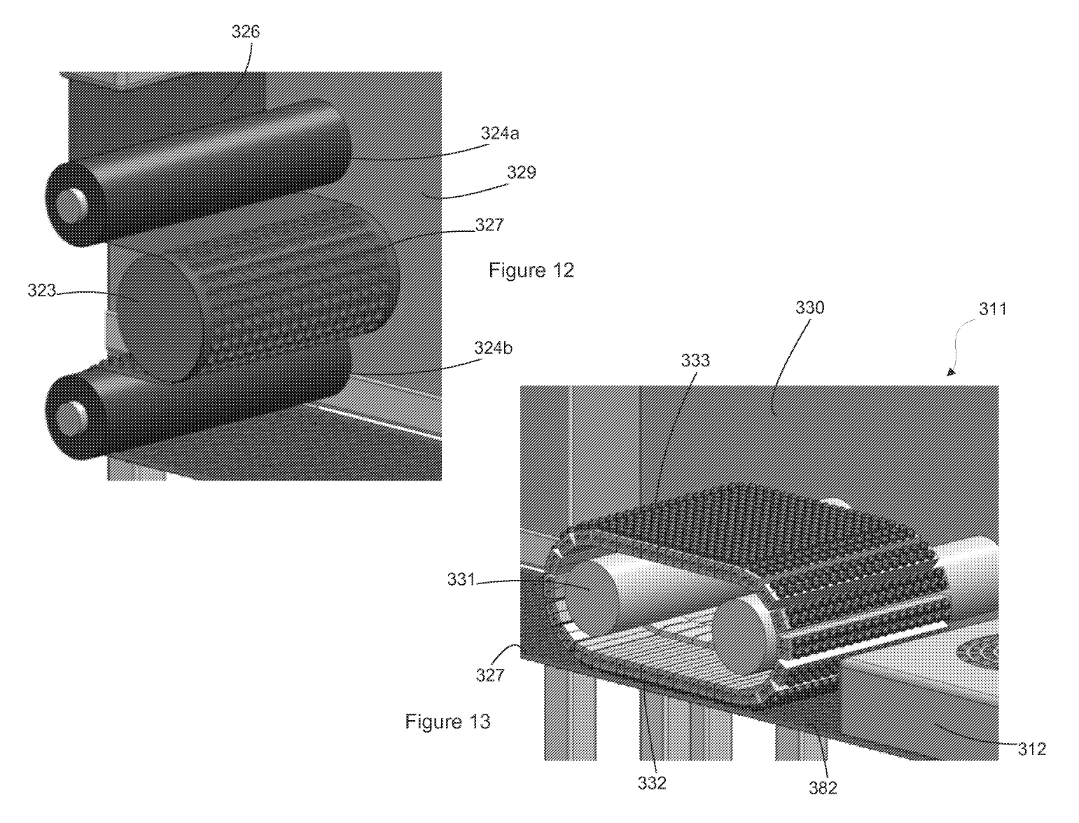

As shown in FIG. 12, the film feeding and thermoforming station 310 comprises a cavity forming unit 323 comprising a plurality of mold cavities (not shown) and a pair of tensioner rollers 324a,324b that keep the film 326 taut over the cavity forming unit 323. The cavity forming unit 323 is operably connected to a vacuum former 329 that permits a vacuum to be drawn in the cavity forming unit 323, which thereby draws the film 326 into the mold cavities in the cavity forming unit 323 so that a plurality of corresponding film cavities 327 are formed therein. In this embodiment, the film cavities are formed by vacuum-forming female mold cavities. In alternate embodiments, a male mold cavity/protrusion could be used. The film 326 is then advanced to the filling and cooling station 311.

The filing and cooling station 311 is partially shown in FIG. 13, and comprises a filling unit 330, a filling tube 331, and a plurality of feed nozzles 333 that move around a track 332. As the film 326 is advanced down the line 301, confectionery product is fed from the filling unit 330, through the filling tube 331 and feed nozzles 333, and into the individual film cavities 327 that have been formed in the film 326. The rotational speed of the track 332 is matched with the linear speed of the movement of the film 326. The confectionery 382 located in the filled film cavities 327 then passes below the cooling unit 312 before reaching the sealing station 321, where a lid film 343 is fed from a lid film reel 342 and sealed to the film 326 to form an array of filled-in packs 369.

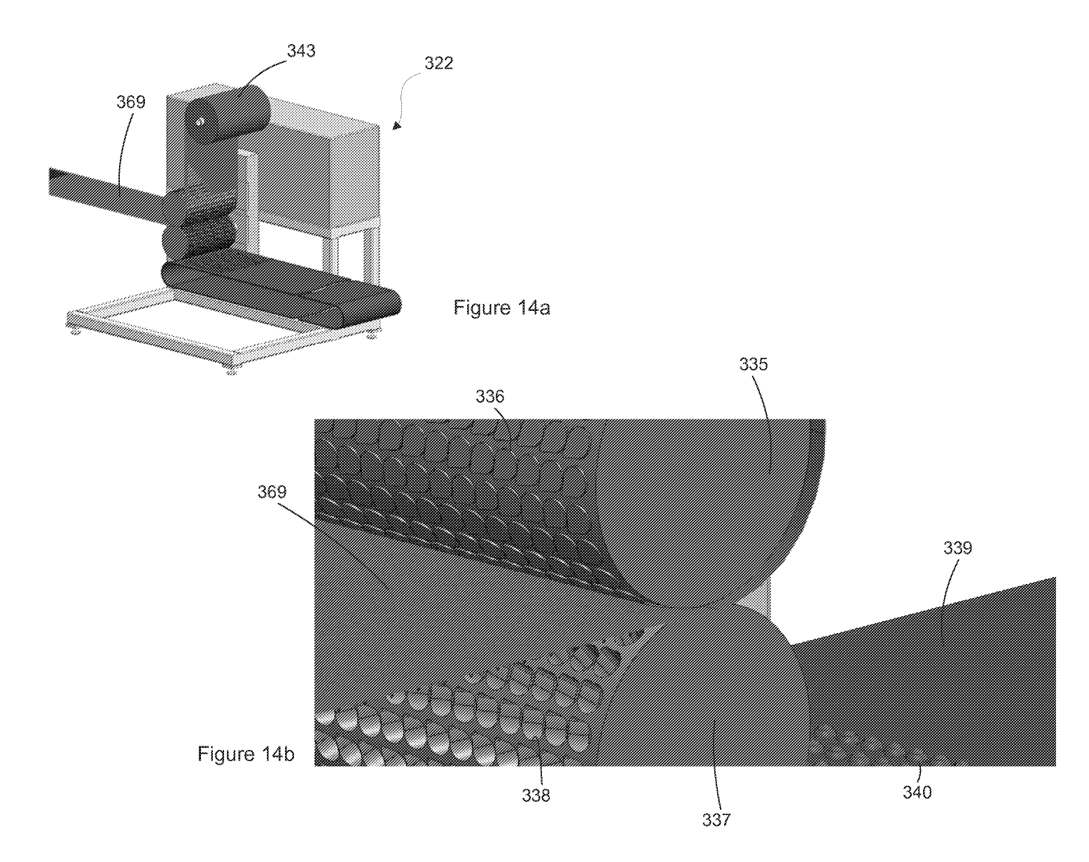

The cutting station 322 is shown in detail in FIGS. 14a and 14b, and comprises a cutting roller 335 comprising a plurality of blades 336 and a pack holding and transfer roller 337 comprising a plurality of pack cavities 338. Each of the pack cavities 338 corresponds with the size and dimensions of an individual unit of confectionery product. The array of filled-in packs 369 enters the plurality of pack cavities 338 and come into contact with the blades 336 of the counter-rotating cutting roller 335, thereby leaving a plurality of filled-in packs 340. The filled-in packs 340 are then moved via a belt 339, optionally to an additional cooling station or a packaging station (not shown).

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

1. A method of making a confectionery having at least one component, the method comprising:
(a) forming at least one film cavity in a carrier film by causing each of the at least one film cavity to conform to and nest with one of at least one mold cavity of a first mold, each of the at least one mold cavity having a mold shape;
(b) depositing a first confectionery component of the at least one component into each of the at least one film cavity, the first confectionery component being in liquid phase at the beginning of the depositing step;
(c) cooling the deposited first confectionery component until it at least partially solidifies;
(d) attaching a sealing film to the carrier film to create at least one sealed internal volume, each of the at least one sealed internal volume being defined by the sealing film and one of the at least one film cavity; and
(i) before performing step (a), extending over a platen a first portion of the carrier film from a roll of the carrier film, securing the first portion of the carrier film to the platen, and cutting the first portion of the carrier film thereby completely disconnecting the first portion of the carrier film from the roll of the carrier film.

2. The method of claim 1, further comprising:
(e) after performing step (b), applying a forming mold having a forming shape to the deposited first confectionery component until the deposited first confectionery component is sufficient solidified to retain the forming shape when the forming mold is separated from the deposited first confectionery component.

3. The method of claim 2, further comprising, prior to and/or during the performance of step (e), cooling the forming mold to a temperature that is no greater than a temperature at which the first confectionery component will solidify.

4. (canceled)

5. (canceled)

6. (canceled)

7. The method of claim 1, wherein the forming step comprises heating and applying a vacuum to each of the at least one film cavity.

8. The method of claim 7, wherein the step of applying a vacuum to each of the at least one film cavity comprises applying a vacuum to at least one hole formed in each of the at least one mold cavity.

9. The method of claim 1, further comprising:
(h) performing step (b) with each of the at least one film cavity nested with one of the at least one mold cavity.

10. The method of claim 1, further comprising:
(h) after performing step (a), keeping each of the at least one film cavity nested with one mold cavity at least until step (d) has been performed.

11. The method of claim 1, wherein step (a) comprises forming at least one film cavity of a carrier film by causing each of the at least one film cavity to conform to and nest with one of at least one mold cavity of a first mold, each of the at least one mold cavity having a mold shape, the first mold comprising a platen having a plurality of mold cavities.

12. (canceled)

13. The method of claim 1, further comprising:
(j) performing steps (a) through (d) along a path that is non-linear.

14. The method of claim 1, further comprising:
(k) providing a carrier film having sufficient rigidity to maintain a shape of the at least one film cavity if the first confectionery component is warmed to a liquid phase after step (d) has been performed.

15. The method of claim 1, further comprising:
(l) after performing step (d), cutting the carrier film and sealing film into a plurality of units, each unit comprising at least one of the at least one film cavity.

16. The method of claim 1, wherein step (d) further comprises bonding the sealing film to the carrier film, the sealing film having a thickness that is less than a thickness of the carrier firm.

17. The method of claim 1, wherein step (d) comprises attaching a sealing film to the carrier film, the sealing film comprising a portion of the carrier film.

18. A method of making a confectionery having at least one component, the method comprising:
(a) securing a carrier film to a platen by extending over the platen a first portion of the carrier film from a roll of the carrier film, securing the first portion of the carrier film to the platen, and cutting the first portion of the carrier film thereby completely disconnecting the first portion of the carrier film from the roll of the carrier film, the platen having a plurality of mold cavities, each of the plurality of mold cavities having a mold shape;
(b) forming a plurality of film cavities in the carrier film by causing the film to nest with and conform to the mold shape of each of the plurality of mold cavities;
(c) depositing a first confectionery component of the at least one component into each of the plurality of film cavities, the first confectionery component being in liquid phase at the beginning of the depositing step;
(d) cooling the deposited first confectionery component until it at least partially solidifies;
(e) attaching a sealing film to the carrier film to create a plurality of sealed internal volumes, each of the of sealed internal volumes being defined by the sealing film and one of the plurality of film cavities; and
(f) after performing step (b), keeping the carrier film secured to the platen and keeping each of the plurality of film cavities nested with one of the plurality of mold cavities at least until step (e) has been performed.

19. The method of claim 18, further comprising:
(g) after performing step (c), applying a forming mold having a forming shape to the deposited first confectionery component until the deposited first confectionery component is sufficient solidified to retain the forming shape when the forming mold is separated from the deposited first confectionery component.

20. The method of claim 19, further comprising, prior to and/or during the performance of step (g), cooling the forming mold to a temperature that is no greater than a temperature at which the first confectionery component will solidify.

21. (canceled)

22. (canceled)

23. (canceled)

24. The method of claim 18, wherein the forming step comprises heating and applying a vacuum to each of the plurality of film cavities.

25. The method of claim 24, wherein the step of applying a vacuum to each of the plurality of film cavities comprises applying a vacuum to at least one hole formed in each of the plurality of mold cavities.

26. (canceled)

27. The method of claim 18, wherein step (e) comprises attaching a sealing film to the carrier film, the sealing film comprising a portion of the carrier film.
